(19) United States
(12) Patent Application Publication
(10) Pub. No.: US 2002/0005493 A1
(43) Pub. Date: Jan. 17, 2002

(54) Optical components for microarray analysis

(76) Inventors: Steven A. Reese, Shoreline, WA (US); Steven C. Quarre, Woodinville, WA (US); Carl S. Brown, Seattle, WA (US); Paul C. Goodwin, Shoreline, WA (US)

Correspondence Address: JAMES T. HAGLER, Fish & Richardson P.C., Suite 500, 4350 La Jolla Village Drive, San Diego, CA, 92122, US

(21) Appl. No.: 09/826,561

(22) Filed: Apr. 4, 2001

Related U.S. Application Data
(60) Provisional application No. 60/194,574, filed on Apr. 4, 2000.

(51) Int. Cl. G01N 21/64

(52) U.S. Cl. 250/459.1

(57) ABSTRACT

The method of illumination of a microarray sample may contribute to the signal-to-background ratio. An oblique illumination technique is used to reduce the reflections from the sample to the detector. The sample may also be moved to the backside of the sample support to reduce the reflections caused by the sample support. In addition, a parallel scanning technique may be used to ensure proper alignment of the sample.

### CROSS-REFERENCE TO RELATED APPLICATIONS

This application claims benefit of U.S. Provisional Application No. 60/194,574, filed Apr. 4, 2000.

### TECHNICAL FIELD

This invention relates to microarray analysis, and more particularly to optical components used in microarray analysis.

### BACKGROUND

Biomedical research has made rapid progress based on sequential processing of biological samples. Sequential processing techniques have resulted in important discoveries in a variety of biologically related fields, including, among others, genetics, biochemistry, immunology and enzymology. Historically, sequential processing involved the study of one or two biologically relevant molecules at the same time. These original sequential processing methods, however, were quite slow and tedious. Study of the required number of samples (up to tens of thousands) was time consuming and costly.

A breakthrough in the sequential processing of biological specimens occurred with the development of techniques of parallel processing of the biological specimens, using fluorescent marking. A plurality of samples are arranged in arrays, referred to herein as microarrays, of rows and columns into a field, on a substrate slide or similar member. The specimens on the slide are then biochemically processed in parallel. The specimen molecules are fluorescently marked as a result of interaction between the specimen molecule and other biological material. Such techniques enable the processing of a large number of specimens very quickly.

In microarray experiments, the sample volume may be very limited. Furthermore, amplification methods (e.g. polymerase chain reaction, etc.) may not be sufficiently quantitative for this application. Even more so, the very biomolecular species that are most likely to prove to be important in these assays are the very ones that are least abundant. All of these factors influence the need for a microarray scanner to be as sensitive as possible. For a fluorescent application such as this, one critical decision is how to deliver as much excitation light as possible without increasing the background of the image. To do otherwise has no value since the signal-to-background ratio would not improve.

### SUMMARY

The method of illumination of a microarray sample may contribute to the signal-to-background ratio. An oblique illumination technique is used to reduce the reflections from the sample to the detector. The sample may also be moved to the backside of the sample support to reduce the reflections caused by the sample support. In addition, a parallel scanning technique may be used to ensure proper alignment of the sample.

### DESCRIPTION OF DRAWINGS

The details of one or more embodiments of the invention are set forth in the accompanying drawings and the description below. Other features, objects, and advantages of the invention will be apparent from the description and drawings, and from the claims.

FIG. 1 is a front view of an illumination system using a beam splitter as is known in the art.

FIG. 2 is a front view of an illumination system using an oblique illumination light path according to one embodiment of the present invention.

FIG. 3 is a front view of an illumination system using front-side illumination showing the light propagation according to one embodiment of the present invention.

FIG. 4 is a front view of an illumination system using back-side illumination showing the light propagation according to one embodiment of the present invention.

FIG. 5 illustrates a parallel scanning technique to obtain samples during microarray analysis according to one embodiment of the present invention.

Like reference symbols in the various drawings indicate like elements.

### DETAILED DESCRIPTION

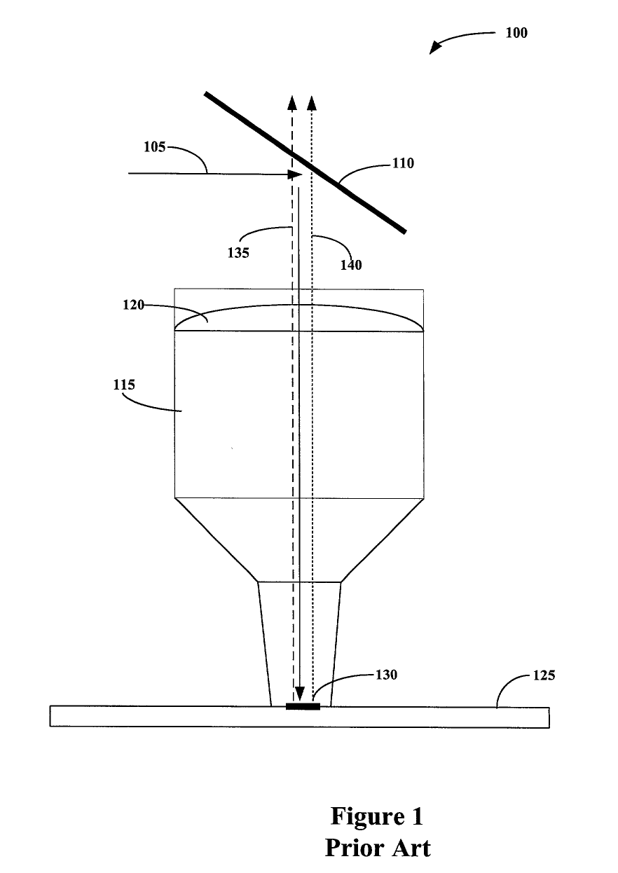

The most common method of illuminating the sample for fluorescence is to use so called epi-illumination as illustrated in FIG. 1. In this method, the illumination and the emission share at least part of the optical train. Light enters the optic train from a source 105 and reflects off of a beam splitter 110. The light then enters an objective 115, travels through a series of internal lenses 120, and on to the sample 130. The sample 130 is typically mounted on a support 125, such as a glass microscope slide. Fluorescent light 135 that is generated at the sample traverses back through the objective lens 120 and the beam splitter 110 and continues on for data collection. The sensitivity of epi-illumination based systems is limited by the autofluoresence of the optical elements and reflection of illumination light off of the sample 130 and the internal lens elements 120 which contribute to background in the collected image. The signal in an epi-illumination system is further limited by the efficiency with which the beam splitter 110 can transmit and reflect light. The beam splitter 110 also greatly reduces the flexibility of the system since the beam splitter 110 must be matched to the excitation and emission filters.

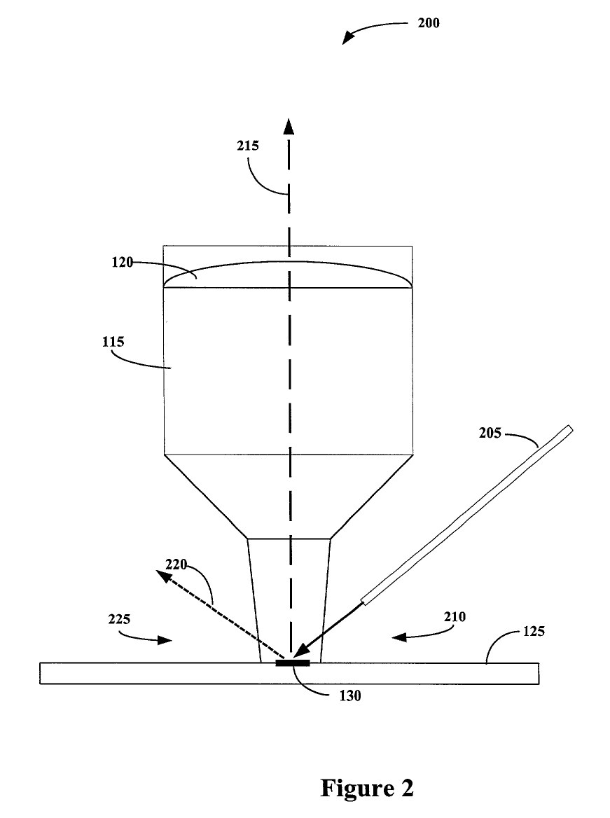

One embodiment of the present invention uses oblique illumination for microarrays as seen in FIG. 2. With oblique illumination, light is delivered through fiber optic fibers 205 or some other comparable light source outside of the objective lens 115. The illumination is directed at an angle 210 such that the illumination is outside of the acceptance angle of the objective lens 115. In one example, the light is delivered at a 45° angle, well outside of the 11.5° angle of an 4×/0.2NA objective lens. Any fluorescence generated at the sample 130 is collected by the objective lens 115. The portion of the illumination light that is reflected 220 by the sample is deflected at the illumination angle 210, in this example, 45 degrees 225. In so doing, neither the illumination nor the reflection 220 of the illumination are collected by the objective lens 115 as they fall outside of the acceptance angle of the lens. As the illumination did not traverse any of the light collection optics, there is no background generated by either internal reflections in the objective lens 115 or by autofluorescence of the optical components. The net effect is bright illumination to the sample with greatly reduced contributions to the background which generates superior signal-to-background over conventional epi-illumination methods.

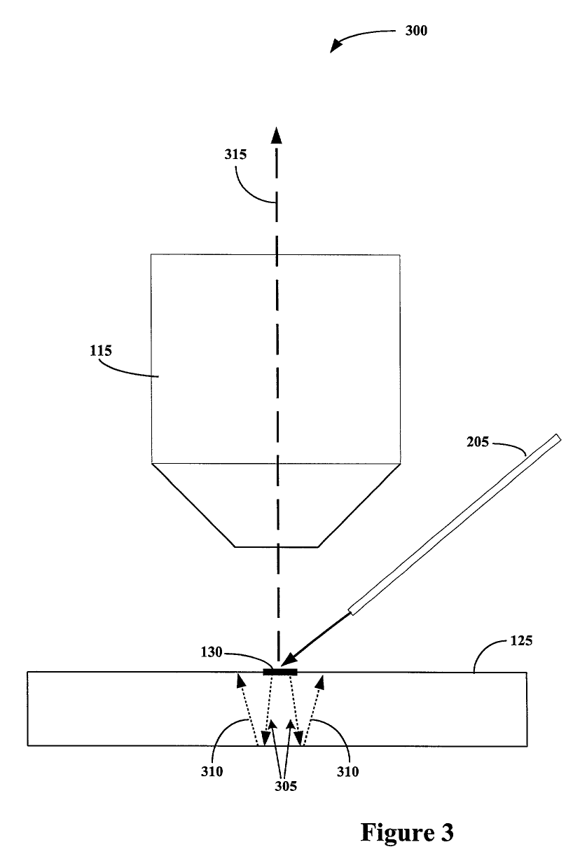

In addition to the light path, the orientation of the specimen also effects the illumination. With front-side illumination and detection, the sample 130 is closest to the optics as seen in FIG. 3. In front-side illumination and detection, the sample 130 sits on the top side of the sample support 125. The illumination source 205 and the objective 115 are on the same side of the sample support 125 as the sample 130. Fluorescence is generated at the sample 130 and a portion of the fluorescence 315 is collected directly by the objective 115 and transmitted on to the detector. Of all of the fluorescence generated at the sample 130, a portion 305 enters the sample support 125 and internally reflects back 310 past the sample 130 and is collected by the objective 115. This internal reflection 310 contributes undesirably to the total fluorescence in the form of background. As a result, the signal-to-background ratio is significantly reduced.

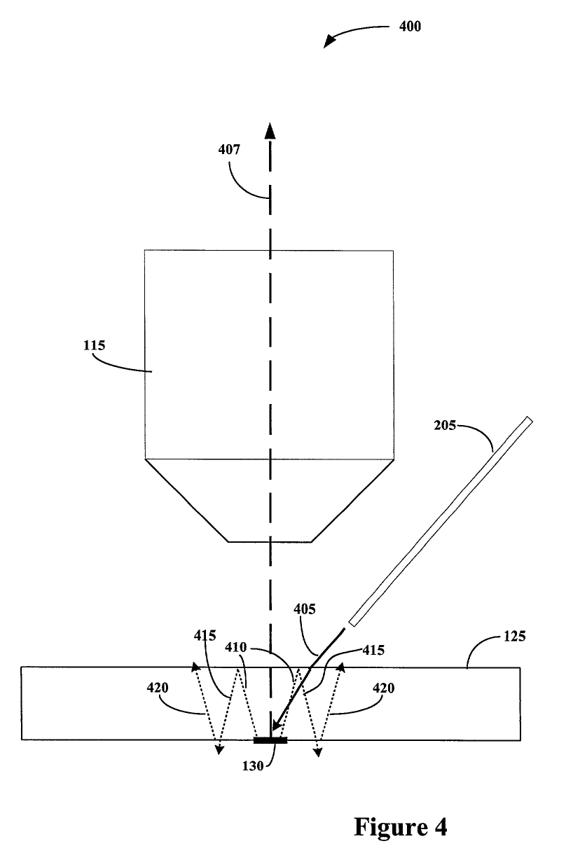

To reduce this reflection and increase the signal-to-background ratio, the sample support 135 is inverted creating Back-Side Illumination and Detection as seen in FIG. 4. With Back-Side Illumination and Detection, the sample 130 is on the opposite side of the sample support 125 than the objective 115 and source illumination 205. Light 405 from the source 205 refracts through the sample support 125 and illuminates the sample 130. Fluorescence 410 generated by the sample 130 transmits through the sample support 125, and a portion 407 travels into the objective 115 and on to the detector. Light internally reflected 415 by the support 125 is directed away from the detector. Some small number of photons may reflect an additional time 420 and make it to the detector, but the number of these secondary reflections relative to the total fluorescent signal is small. The total amount of signal using Back-Side Illumination and Detection is nearly twice what it is for Front-Side Illumination

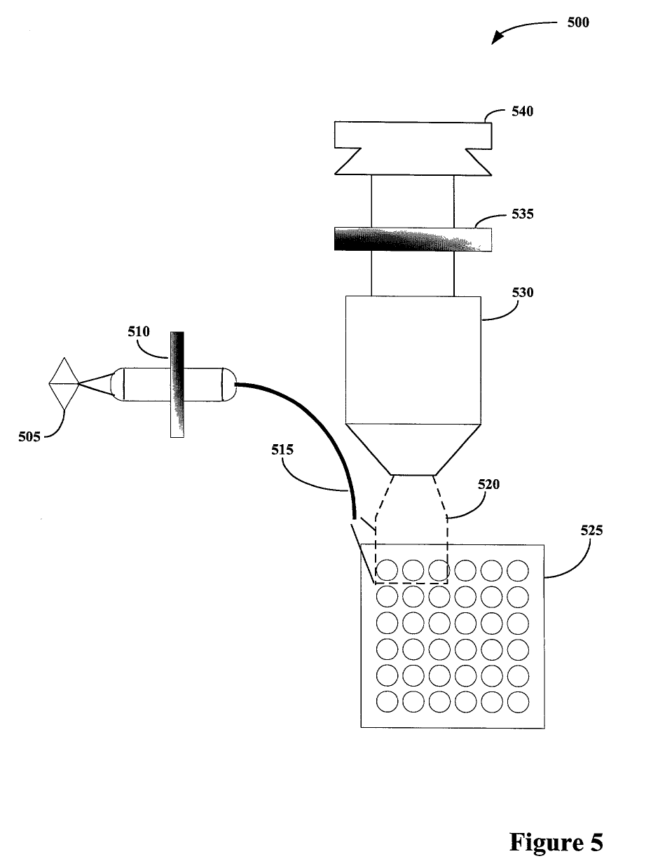

Most applications for microarray scanners use internal controls for every sample. That is, for every measurement made, there is an independent control sample. The experimental value is then expressed as a ratio of the experimental value normalized to the control value. This is referred to as a ratiometric measurement. Ratiometric measurements are powerful methods in that every sample is independently controlled. The weakness of ratiometric measurements is that they place strict requirements on the instrumentation that generates the measurements. Division, the mathematical operation that is used for generating ratios, does not gracefully tolerate values that approach zero. This effect is primarily seen as the denominator intensity approaches zero. I that case, this drives the ratio to infinity and values of zero become undefined. Consequently, in imaging applications, exact alignment of images representing the experimental and control signals are critical. In commercially available laser scanning instruments, one of two methods for acquiring multiple wavelength images in employed. In some systems, the sample is scanned once for each fluorochrome in the sample. Since the different scans require a different mechanical scanning of the sample, the images are very difficult to perfectly align. In other systems, multiple fluorochromes are scanned for at the same time using off-set points for each wavelength. Even in this method, the images are often misaligned. In the present invention, the optical path is held constant and the sample is scanned beneath the optics. At each physical location, all of the fluorochromes in use are acquired in succession (FIG. 5). Consequently, the images from the acquisitions of each fluorochrome are limited not by mechanical rescanning but solely by the chromatic error in the optics. By controlling the chromatic error (through careful lens design) the chromatic error for each point in the image is smaller than the size of our detection element (i.e. sub-pixel) so it will not deteriorate the ratiometric data.

FIG. 5 illustrate a Parallel Scanning technique used in the present invention. With Parallel Scanning, light is generated by a single source such as an arc lamp 505 that is broad spectrum. An interference filter 510 is used to select excitation wavelengths. The light is launched into a fiber bundle 515 that delivers light essentially uniformly to a panel 520 on the sample 525. Fluorescence is collected by optics, such as an objective lens 530 and passes through an additional interference filter 535 which is used to achieve a high level of wavelength specificity. The light is then detected by a parallel collection device such as a charge-coupled device (CCD) camera 540. In order to acquire additional fluorescence channels, only the interference filters 510, 535 are changed and the remainder of the opto-mechanical path is held fixed. The interference filters 510, 535 may be held in a housing of sealed filter wheels (not shown). The filter wheels may include mechanical and sensor technology to easily change the current filter. To scan the remainder of the sample 525, the sample 525 is moved panel by panel under the fixed optical path until the entire sample 525 has been scanned. In this way, the alignment of the images representing each fluorescent probe are in alignment to greater precision than the size of the individual detectors in the CCD camera 540.

A number of embodiments of the invention have been described. Nevertheless, it will be understood that various modifications may be made without departing from the spirit and scope of the invention. Accordingly, other embodiments are within the scope of the following claims.

What is claimed is:

1. A method of illuminating a sample comprising:
positioning the sample beneath a detector; and
directing a light source at the sample at an angle such that reflections of the light source off the sample are directed away from the detector.

2. The method of claim 1, further comprising setting the angle to an oblique angle.

3. The method of claim 1, further comprising setting the angle so that the reflections are directed away from the sample at approximately the angle.

4. The method of claim 1, further comprising setting the angle outside an acceptance angle of an objective lens.

5. The method of claim 1, wherein the sample is a microarray sample.

6. The method of claim 1, further comprising providing illumination using fiber optics.

7. The method of claim 1, further comprising collecting fluorescence generated at the sample with the detector.

8. A method of illuminating a sample comprising:
positioning the sample on a lower side of a sample support; and
directing an illumination source through the sample support to the sample.

9. The method of claim 8, further comprising directing the illumination source at the sample at an oblique angle.

10. The method of claim 8, further comprising providing illumination using fiber optics.

11. The method of claim 8, further comprising collecting fluorescence generated at the sample with a detector.

12. The method of claim 11, further comprising positioning the sample support between the sample and the detector.

13. The method of claim 8, wherein the illumination source refracts through the sample support.

14. The method of claim 8, further comprising positioning a microarray sample on the sample support.

15. A method of obtaining a plurality of samples of a microarray comprising:
exciting the microarray with an illumination source;
aligning a first portion of the microarray with a detector;
collecting the fluorescence from the first portion of the microarray;
moving the microarray to align a second portion of the microarray with the detector; and
collecting the fluorescence from the second portion of the microarray.

16. The method of claim 15, further comprising repositioning the microarray until fluorescence is obtained from the entire microarray.

17. The method of claim 15, further comprising collecting the fluorescence of each subsequent portion of the microarray prior to further repositioning.

18. The method of claim 15, further comprising adjusting a fluorescence channel of the illumination source.

19. The method of claim 18, further comprising changing interference filters to adjust the fluorescence channel.

20. The method of claim 15, further comprising collecting the fluorescence with a charge-coupled device.
